(19) United States
(12) Patent Application Publication
(10) Pub. No.: US 2021/0046786 A1
(43) Pub. Date: Feb. 18, 2021

(54) Pneumatic Tire

(71) Applicant: The Yokohama Rubber Co., LTD., Minato-ku, Tokyo (JP)

(72) Inventor: Hiroki Fujimori, Hiratsuka-shi, Kanagawa (JP)

(21) Appl. No.: 16/980,366

(22) PCT Filed: Dec. 19, 2018
(86) PCT No.: PCT/JP2018/046809

§ 371 Date: Sep. 11, 2020

(30) Foreign Application Priority Data
Mar. 12, 2018 (JP) 2018-044119

(51) Int. Cl. B60C 15/04; B60C 9/00; C08L 45/00

(52) U.S. Cl. CPC B60C 15/04; C08L 45/00; B60C 9/0007

(57) ABSTRACT

Provided is a pneumatic tire having excellent durability by defining a viscosity and a softening point of a coumarone resin within predetermined ranges. The pneumatic tire uses a reinforcing material having a coumarone resin film formed on a surface thereof. The coumarone resin film includes a coumarone resin having a viscosity from 350 to 2200 Pa·sec at a temperature of 160° C. and a softening point from 75 to 130° C., and the reinforcing material is at least one of a bead wire or a steel cord. The coumarone resin film preferably has a thickness from 0.05 to 0.40 μm. The reinforcing material is preferably the bead wire or the steel cord.

Provided is a pneumatic tire using a reinforcing material having a coumarone resin film formed on a surface thereof. The coumarone resin film includes a coumarone resin having a viscosity from 350 to 2200 Pa·sec at a temperature of 160° C. and a softening point from 75 to 130° C., and the reinforcing material is at least one of abead wire or a steel cord.

### TECHNICAL FIELD

The present technology relates to a pneumatic tire using a bead wire or a steel cord having a coumarone resin film formed thereon as a reinforcing material and particularly relates to a pneumatic tire having improved durability by defining a viscosity and a softening point of a coumarone resin within predetermined ranges.

### BACKGROUND ART

Currently, a metal reinforcing material made of high-carbon steel, which is superior in strength and rigidity, is used as a reinforcing material for a belt layer and a bead portion in a tire of a vehicle or the like. Adhesion between the steel cord (reinforcing material) and rubber is important. When they do not firmly adhere to each other, an adhesive strength of the steel cord to the rubber may deteriorate due to, for example, heat or moisture generated while running the tire, and the steel cord, which is the reinforcing material, and the rubber may be separated from each other, leading to a cause of a tire failure.

In the related art, for example, at the time of bead insulation, in order to increase adhesion between a rubber composition in an unvulcanized state and a bead wire to prevent rubber from being separated from the bead wire, gasoline is applied onto a surface of the bead wire to melt a surface of the rubber composition in the unvulcanized state coated thereon, thereby enhancing the adhesion of the rubber composition to the bead wire.

Furthermore, it has been performed to increase the adhesion at the time of the insulation that the surface of the bead wire is heated to about 100° C. to enable the rubber composition in the unvulcanized state and bead wire to initially adhere to each other.

Meanwhile, for anti-rust purposes, a coumarone resin is applied to suppress oxidation degradation of the bead wire or the steel cord when transferred. In some cases, the insulation is performed after gasoline is coated on the surface of the bead wire onto which the coumarone resin is applied.

For example, Japan Patent No. 5403123 describes applying a coumarone resin or the like onto a surface of a bead wire, and Japan Unexamined Patent Publication No. 2011-073609 describes applying a coumarone resin or the like onto a surface of a steel cord.

Japan Patent No. 5403123 describes a pneumatic tire using a bead wire on which a coumarone resin film is formed. The coumarone resin forming the coumarone resin film has a melting point higher than 75° C. and lower than a heating temperature (° C.), and an amount of the coumarone resin applied onto the bead wire is from 0.04 to 0.08 g/wire kg/wire mm.

Japan Unexamined Patent Publication No. 2011-073609 describes that a resin film made of a coumarone resin or a resorcin resin is coated on a surface of a rubber-containing steel cord formed by twisting a plurality of steel wires together with an unvulcanized rubber composition filled in an internal void between the wires.

As described above, it has been known that a coumarone resin or the like is applied onto a surface of a bead wire or a surface of a steel cord, but the simple application of the coumarone resin to the bead wire or the steel cord may result in a decrease in adhesion between unvulcanized rubber and metal because they are in tight contact with each other. In arriving at the present technology, it was noted that there was a need to consider a viscosity of the coumarone resin to suppress the decrease in adhesion.

### SUMMARY

The present technology provides a pneumatic tire having excellent durability by defining the viscosity and the softening point of the coumarone resin within predetermined ranges.

According to an embodiment of the present technology, there is provided a pneumatic tire using a reinforcing material having a coumarone resin film formed on a surface thereof, the coumarone resin film including a coumarone resin having a viscosity from 350 to 2200 Pa·sec at a temperature of 160° C. and a softening point from 75 to 130° C., and the reinforcing material being at least one of a bead wire or a steel cord.

The coumarone resin film preferably has a thickness from 0.05 to 0.40 μm.

According to an embodiment of the present technology, the pneumatic tire having excellent durability can be provided by defining the viscosity and the softening point of the coumarone resin forming the coumarone resin film, which is formed on the surface of the reinforcing material, within the predetermined ranges, to increase the adhesion between the rubber composition and the reinforcing material.

### BRIEF DESCRIPTION OF DRAWINGS

FIG. 1 is a cross-sectional view illustrating a cross-sectional shape of a pneumatic tire according to an embodiment of the present technology.

FIG. 2A is a schematic cross-sectional view illustrating a bead core, and FIG. 2B is a schematic perspective view illustrating a bead wire used in the bead core.

FIG. 3A is a schematic cross-sectional view illustrating a bead core used in a bead pull-out test, and FIG. 3B is a schematic side view illustrating a test sample for testing the bead core used in the bead pull-out test.

### DETAILED DESCRIPTION

Pneumatic tires according to preferred embodiments of the present technology will be described in detail below as illustrated in the accompanying drawings.

As described above, in light of the fact that the simple application of the coumarone resin to the bead wire or the steel cord may result in a decrease in adhesion of the bead wire or the steel cord to the rubber composition in the unvulcanized state, it was noted in arriving at the present technology that there was a need to consider a viscosity of the coumarone resin to suppress the decrease in adhesion.

According to an embodiment of the present technology, a coumarone resin film is formed on a surface of the bead wire using the coumarone resin having a high viscosity to suppress a decrease in adhesion after insulation and improve the durability of a tire.

In addition, according to an embodiment of the present technology, a coumarone resin film is formed on a surface of the steel cord using the coumarone resin having a high viscosity to suppress a decrease in adhesion from rolling to vulcanization and improve the durability of a tire.

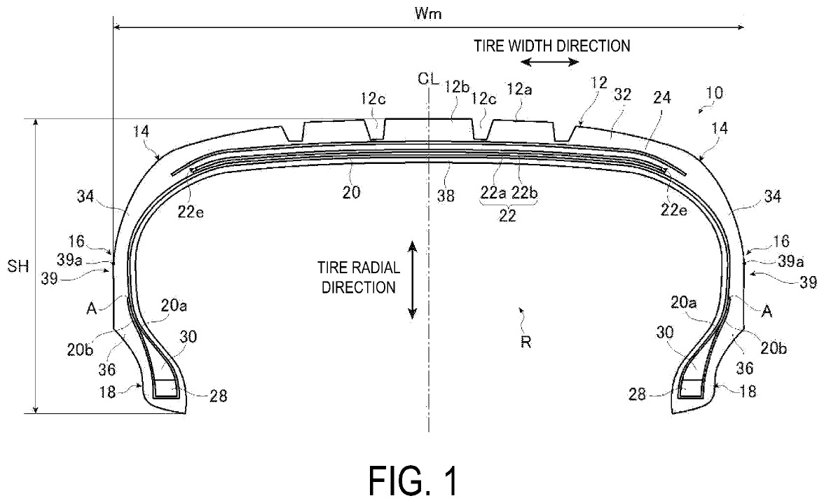

FIG. 1 is a cross-sectional view illustrating a cross-sectional shape of a pneumatic tire according to an embodiment of the present technology.

A pneumatic tire 10 illustrated in FIG. 1 (hereinafter also referred to simply as “tire”) includes a tread portion 12, shoulder portions 14, sidewall portions 16, and bead portions 18 as major constituent portions. Hereinafter, as indicated by arrows in FIG. 1, “tire width direction” refers to the direction parallel with a rotation axis (not illustrated) of the tire, and “tire radial direction” refers to the direction orthogonal to the rotation axis. “Tire circumferential direction” refers to the rotating direction with the rotation axis as the axis at the center of rotation.

Further, “tire inner side” refers to a lower side of the tire in the tire radial direction of FIG. 1, that is, an inner surface side of the tire facing a cavity region R that gives a predetermined internal pressure to the tire, and “tire outer side” refers to an upper side of the tire in FIG. 1, that is, an outer surface side of the tire visible to a user on an opposite side of an inner circumferential surface of the tire. Reference sign CL in FIG. 1 denotes a tire equatorial plane. The tire equatorial plane CL is a plane orthogonal to the rotation axis of the pneumatic tire 10 while passing through the center of the width of the pneumatic tire 10.

The tire 10 mainly includes a carcass layer 20, a belt layer 22, an auxiliary belt-reinforcing layer 24, bead cores 28, bead fillers 30, a tread rubber layer 32 forming the tread portion 12, sidewall rubber layers 34 forming the sidewall portions 16, rim cushion rubber layers 36, and an inner liner rubber layer 38 provided on the inner circumferential surface of the tire.

Land portions 12b forming a tread surface 12a of the tire outer side and tread grooves 12c formed in the tread surface 12a are provided in the tread portion 12. The land portions 12b are defined by the tread grooves 12c. The tread grooves 12c include main grooves formed continuously in the tire circumferential direction and a plurality of lug grooves (not illustrated) extending in the tire width direction. The tread surface 12a has a tread pattern formed by the tread grooves 12c and the land portions 12b.

A maximum width Wm of the tire 10 in the tire width direction is a distance between maximum width positions 39a that are positions representing a maximum length between tire sides 39 in the tire width direction. Regions within ±30% of a tire cross-sectional height SH in the tire radial direction on the basis of the maximum width positions 39a of the tire are called side treads.

In the bead portions 18, a pair of left and right bead cores 28 functioning to fix the tire 10 to a wheel is provided, while the carcass layer 20 is folded back around the pair of bead cores 28. Additionally, the bead fillers 30 are also provided in the bead portions 18 in such a manner as to contact the bead cores 28. Therefore, the bead core 28 and the bead filler 30 are sandwiched by body portion 20a and folded back portion 20b of the carcass layer 20. The carcass layer 20 extends from a portion corresponding to the tread portion 12 in the tire width direction through portions corresponding to the shoulder portions 14 and the sidewall portions 16 to the bead portions 18 to form a skeleton of the tire 10.

The carcass layer 20 is formed by coating a plurality of organic fiber cords arranged as reinforcing cords with cord coating rubber. The carcass layer 20 has end portions A at the sidewall portions 16 by being folded back around the pair of left and right bead cores 28 from the tire inner side to the tire outer side, such that the body portion 20a and the folded back portions 20b are delimited by the bead cores 28. That is, the carcass layer 20 is provided as one layer between the pair of left and right bead portions 18.

In addition, the carcass layer 20 may be made of one sheet material or a plurality of sheet materials. When the carcass layer 20 is made of a plurality of sheet materials, the carcass layer 20 has a joint portion (splice portion). The carcass layer 20 will be described in detail below.

As the cord coating rubber of the carcass layer 20, one or more types of rubber selected from natural rubber (NR), styrene-butadiene rubber (SBR), butadiene rubber (BR), and isoprene rubber (IR) are preferably used. Furthermore, these types of rubber are terminal-modified by a functional group containing an element such as nitrogen, oxygen, fluorine, chlorine, silicon, phosphorus, or sulfur, for example amine, amide, a hydroxyl group, ester, ketone, siloxy, or alkylsilyl, or terminal-modified by epoxy for use as the cord coating rubber of the carcass layer 20.

Carbon black is used to be blended with these types of rubber, for example, with an iodine adsorption amount from 20 to 100 g/kg, preferably from 20 to 50 g/kg, a DBP absorption amount from 50 to 135 cm³/₁00 g, preferably from 50 to 100 cm³/₁00 g, and a CTAB (cetyl trimethylammonium bromide) adsorption specific surface area from 30 to 90 m²/g, preferably from 30 to 45 m²/g.

In addition, an amount of sulfur used is, for example, from 1.5 to 4.0 parts by mass, preferably from 2.0 to 3.0 parts by mass per 100 parts by mass of the rubber.

The belt layer 22 is a reinforcing layer attached to the carcass layer 20 in the tire circumferential direction to reinforce the carcass layer 20. The belt layer 22 is provided on an outer side of the carcass layer 20 in the tire radial direction. The belt layer 22 includes an inner belt layer 22a and an outer belt layer 22b provided in a portion corresponding to the tread portion 12.

The inner belt layer 22a and the outer belt layer 22b each include a plurality of reinforcing cords (reinforcing materials) inclined with respect to the tire circumferential direction, and the reinforcing cords are arranged to cross one another between the layers. The inner belt layer 22a and the outer belt layer 22b are formed by coating the reinforcing cords, for example steel cords, with the above-described cord coating rubber or the like.

Concerning the belt layer 22, an angle of the reinforcing cords of the inner belt layer 22a and the outer belt layer 22b with respect to the tire circumferential direction is, for example, from 24° to 35°, preferably from 27° to 33°. Thus, high speed durability can be improved.

The reinforcing cords in both the inner belt layer 22a and the outer belt layer 22b of the belt layer 22 are not limited to the steel cords, and a steel belt may be applied to only one of the inner belt layer 22a and the outer belt layer 22b. Also, known reinforcing cords, including organic fiber cords or the like made of polyester, nylon, aromatic polyamide, or the like may be applied to at least one of the inner belt layer 22a or the outer belt layer 22b.

In the tire 10, the auxiliary belt-reinforcing layer 24 that reinforces the belt layer 22 is disposed above the outer belt layer 22b, which is the uppermost layer in the belt layer 22, in the tire circumferential direction, that is, outward of the belt layer 22 in the tire radial direction.

The auxiliary belt-reinforcing layer 24 is a band-like member in which, for example, one or a plurality of organic fiber cords are aligned as reinforcing cords and coated with the above-described cord coating rubber or the like. The auxiliary belt-reinforcing layer 24 is a layer auxiliarily reinforcing a belt in the tire circumferential direction by spirally winding the band-like member in the tire circumferential direction. The auxiliary belt-reinforcing layer 24 is spirally disposed in the tire circumferential direction.

The auxiliary belt-reinforcing layer 24 illustrated in FIG. 1 is a so-called full cover configured to cover the belt layer 22 including end portions 22e, for example from an end to the other end of the belt layer 22 in the tire width direction. In addition, the auxiliary belt-reinforcing layer 24 may be a laminate of a plurality of full covers or a combination of the full cover with edge shoulders.

For the organic fiber cords of the auxiliary belt-reinforcing layer 24, for example, nylon 66 (polyhexamethylene adipamide) fibers, aramid fibers, composite fibers consisting of the aramid fibers and the nylon 66 fibers (aramid/nylon 66 hybrid cords), PEN (polyethylene naphthalate) fibers, POK (aliphatic polyketone) fibers, heat-resistant PET (polyethylene terephthalate) fibers, rayon fibers, or the like are used.

Hereinafter, the bead core 28 of the bead portion 18 will be described.

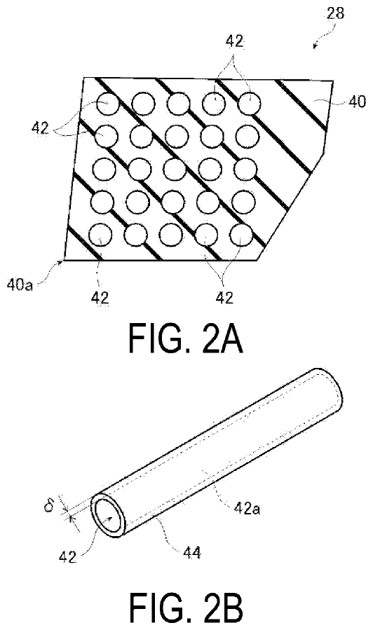

FIG. 2A is a schematic cross-sectional view illustrating a bead core, and FIG. 2B is a schematic perspective view illustrating a bead wire used in the bead core.

As illustrated in FIG. 2A, the bead core 28 includes a rubber composition 40 (insulation rubber) and bead wires 42, and the bead wires 42 are coated with the rubber composition 40. In FIG. 2A, the lower left end indicates a bead toe 40a.

As illustrated in FIG. 2B, the bead core 28 is formed using the bead wires 42 each having a coumarone resin film 44 formed on a surface 42a thereof. As the bead wire 42, a general one used for a tire can be employed. For the coumarone resin film 44, a viscosity and a softening point of a coumarone resin are defined, which will be described in detail below. Furthermore, a preferred thickness δ of the coumarone resin film 44 is defined.

The bead core 28 can be formed by, for example, heating the bead wires 42, each having the coumarone resin film 44 formed on the surface 42a thereof, to a predetermined heating temperature and coating the bead wires 42 with the rubber composition 40 in an unvulcanized state.

According to an embodiment of the present technology, the viscosity and the softening point of the coumarone resin are defined for the coumarone resin film 44. In order to manufacture the bead core 28, the bead wires 42, each having the coumarone resin film 44 formed on the surface 42a thereof, are heated to the predetermined heating temperature and coated with the rubber composition 40 in the unvulcanized state. At this time, the coumarone resin film 44 is not melted into the rubber composition 40. Since the bead wire 42 is not in contact with the rubber composition 40 in the unvulcanized state by means of the coumarone resin film 44, a decrease in adhesion between the rubber composition 40 in the unvulcanized state and the bead wire 42 is suppressed. After vulcanization, the coumarone resin film 44 is melted and absorbed into the rubber composition 40. The coumarone resin film 44 does not remain present on the surface 42a of the bead wire 42, thereby obtaining good adhesion between the bead wire 42 and the rubber composition 40 after vulcanization. Accordingly, the durability of the tire can be improved.

The coating of the bead wires 42 with the rubber composition 40 in the unvulcanized state is called bead insulation. The bead insulation also includes coating bead wires 54 one by one with the rubber composition 40 in the unvulcanized state.

For the rubber composition 40, the above-described cord coating rubber can be used.

A method of heating the bead wires 42 is not particularly limited. Examples thereof include: a heating method in which an electric current is applied to the bead wires 42 (an electric heating method), a heating method using hot air, a heating method by electromagnetic induction, and the like.

The “coumarone resin” is a copolymer of coumarone, indene (C9H8), and styrene (C8H8).

Commercially available coumarone resins generally have a melting point from 40° C. to 120° C. It is known that the melting point of the coumarone resin is changed by changing a molecular weight or a degree of polymerization.

In addition, the coumarone resin may be a polymer having repeating units of coumarone and indene. The coumarone resin can have a further repeating unit other than the above-described repeating units. An example of the repeating unit other than the above-described repeating units includes a repeating unit of at least one selected from the group consisting of styrene, α-methylstyrene, methylindene, or vinyltoluene.

According to an embodiment of the present technology, the coumarone resin has a viscosity from 350 to 2200 Pa·sec at a temperature of 160° C. and a softening point from 75 to 130° C. In addition, the coumarone resin film preferably has the thickness δ from 0.05 to 0.40 μm.

When the coumarone resin has a viscosity of less than 350 Pa·sec at the temperature of 160° C., due to the low viscosity, the coumarone resin on an interface between the reinforcing material, such as the bead wire or the steel cord, and the rubber composition is melted into the rubber composition in the unvulcanized state before vulcanization. Accordingly, the reinforcing material, such as the bead wire or the steel cord, and the rubber composition come into contact with each other, resulting in a decrease in adhesion.

Meanwhile, when the coumarone resin has a viscosity of greater than 2200 Pa·sec at the temperature of 160° C., due to the high viscosity, the coumarone resin remains unmelted at the time of vulcanization and is present on the interface between the reinforcing material, such as the bead wire or the steel cord, and the rubber composition even after vulcanization, resulting in a deterioration in adhesion between the reinforcing material, such as the bead wire or the steel cord, and the rubber composition after vulcanization.

When the softening point is from 75 to 130° C., the coumarone resin is softened at the time of vulcanization, which is performed at a temperature of about 160° C. when manufacturing a tire.

When the coumarone resin film has a thickness of 0.05 μm or less, the reinforcing material, such as the bead wire or the steel cord, comes into contact with the rubber composition in the unvulcanized state, resulting in a decrease in adhesion.

When the coumarone resin film has a thickness of greater than 0.40 μm, after vulcanization, the coumarone resin remains present on the interface between the reinforcing material, such as the bead wire or the steel cord, and the rubber composition after being vulcanized, resulting in a decrease in adhesion between the reinforcing material, such as the bead wire or the steel cord, and the rubber composition.

The thickness of the coumarone resin film can be calculated by thickness (um) of coumarone resin film=1.82×coating amount (g/kg)×wire diameter (mm).

A method of forming the coumarone resin film 44 on the surface 42a of the bead wire 42 is not particularly limited. An applicable example of the method of forming the resin film includes bringing the surface 42a of the bead wire 42 into contact with a cotton yarn, a fabric structure, or the like that is impregnated with a resin solution. That is, when the cotton yarn, the fabric structure, or the like is impregnated with the resin solution, in which a resin is dissolved in a solvent, and then brought into contact with the bead wire 42, the resin solution can be uniformly applied onto the surface 42a of the bead wire 42. In addition, the coumarone resin film 44 can be uniformly formed with no irregularity in thickness to have only the resin on the surface 42a of the bead wire 42 by volatilizing the solvent after being applied. In this case, a string structure is preferably used as a path for supplying the resin solution to the fabric structure. In the method of forming the resin film, a preferred solvent for the resin is, for example, xylene, toluene, ethanol, acetone, or butanol.

According to an embodiment of the present technology, an amount of the coumarone resin to be applied can be adjusted depending on a concentration of the resin solution, a method of winding the cotton yarn, the fabric structure, or the like, etc.

According to an embodiment of the present technology, good adhesion between the rubber composition 40 in the unvulcanized state and the bead wire 42 can be achieved by defining the viscosity and the softening point of the coumarone resin within predetermined ranges. Accordingly, the durability of the bead core 28 can be improved, and furthermore, the tire 10 having excellent durability can be obtained.

According to an embodiment of the present technology, as long as a pneumatic tire uses a reinforcing material having a coumarone resin film formed on a surface thereof, the foregoing can also be applied to a member using a steel cord as the reinforcing material, not being particularly limited to the above-described bead wire. For example, it can be applied to a steel cord that is used as a reinforcing cord in the inner belt layer 22a and the outer belt layer 22b of the belt layer 22, in addition to the bead wire. In this case, the steel cord used in the belt layer 22 has a coumarone resin film formed on a surface thereof. As described above, the coumarone resin used in the coumarone resin film has a viscosity from 350 to 2200 Pa·sec at a temperature of 160° C. and a softening point from 75 to 130° C. In addition, the coumarone resin film formed on the surface of the steel cord preferably has a thickness from 0.05 to 0.40 μm. By forming the coumarone resin film on the surface of the steel cord, a decrease in adhesion can be suppressed from rolling to vulcanization, and the durability of the tire can be improved.

In addition, when the coumarone resin film is present on the interface between the reinforcing material and the rubber composition after vulcanization, the adhesion between the reinforcing material and the rubber composition deteriorates. In terms of adhesion, it is thus ideal in a final form of the tire that the coumarone resin film is not present on the interface between the reinforcing material and the rubber composition, that is, on the surface of the reinforcing material. In the final form of the tire, it is ideal that the coumarone resin is contained in the rubber composition rather than being present on the above-described interface.

As described above, the reinforcing material having the coumarone resin film formed on the surface thereof is not limited to the bead wire and may be, for example, the steel cord of the belt layer 22. In this case, in one tire, both the bead wire and the steel cord of the belt layer 22 can be used as the reinforcing material having the coumarone resin film formed on the surface thereof as described above.

In addition, the type of tire is not particularly limited and may be, for example, a tire for a passenger vehicle, a tire for a truck or a bus, or a tire for a construction vehicle.

The present technology is basically configured as described above. The pneumatic tire according to an embodiment of the present technology has been described in detail above. However, the present technology is not limited to the above-described embodiments, and it is needless to say that various improvements or modifications may be made without departing from the gist of an embodiment of the present technology.

### EXAMPLE 1

Hereinafter, with respect to a pneumatic tire according to an embodiment of the present technology, the features of an embodiment of the present technology will be described in more detail with reference to examples. Materials, reagents, amounts and proportions of substances, operations, and the like described in the following embodiments can be appropriately modified without departing from the gist of an embodiment of the present technology. Thus, the scope of an embodiment of the present technology is not limited to the following embodiments.

In a first embodiment, pneumatic tires for Examples 1 to 5, Conventional Example 1, and Comparative Examples 1 to 3 were manufactured, using coumarone resin films each having a configuration as shown in Table 1 below, and a bead pull-out test was performed for each of the pneumatic tires to evaluate an adhesiveness rate between bead wires and the rubber. Concerning the adhesiveness rate between the bead wires and the rubber, the results are shown in Table 1 below. In addition, the higher adhesiveness rate between the bead wires and the rubber, the superior adhesion, meaning that the tire has higher durability. Thus, the durability of the tire was evaluated based on the adhesiveness rate between the bead wires and the rubber.

Viscosities shown in Table 1 below are viscosities at a temperature of 160° C. Further, a softening point of the coumarone resin films in Examples 1 to 5, Conventional Example 1, and Comparative Examples 1 to 3 is 98° C.

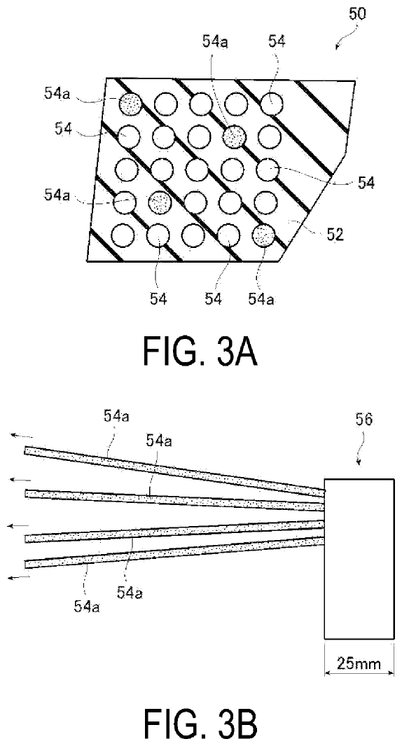

In the present embodiment, a bead core 50 illustrated in FIG. 3A was manufactured, and then a tire was manufactured. The bead core 50 illustrated in FIG. 3A is identical to the bead core 28 illustrated in FIG. 2A in basic configuration.

In the bead core 50, a rubber composition 52 mainly includes the following materials. The materials mainly included in the rubber composition 52 are NR, SBR, CB (carbon black), calcium carbonate, aluminum silicate, aroma-based oil, gum rosin, O,O′-dibenzamide diphenyl disulfide, wax, cobalt naphthenate, salicylic acid, PVI (pre-vulcanization inhibitor), stearic acid, zinc oxide, DZ-G (N,N-dicyclohexyl-2-benzothiazolyl sulfenamide), and sulfur.

In addition, the bead wires 54 and 54a having a diameter of 1.20 mm were used.

The bead wires 54 and the bead wires 54a are identical to each other, and the bead wire 54a is pulled out in a bead pull-out test that will be described below. Therefore, except for the description about the bead pull-out test, the bead wire 54 and the bead wire 54a are not particularly distinguished from each other.

In the bead core 50, five bead wires 54 (one) were arranged in parallel to one another, and the same was stacked to form five layers for a total of 25 windings. The structure of the bead core 50 is also expressed as 25 windings of 5+5+5+5+5.

In the present embodiment, the bead core 50 was formed and then stored in a chamber at a temperature of 30° C. and at a relative humidity (RH) of 90% for four days. Thereafter, a tire having a size of 215/65R16 was manufactured using the bead core 50.

The bead pull-out test was performed with respect to the manufactured tire for an adhesiveness rate (%) of rubber, which was an indicator for evaluating durability, and the durability of the tire was evaluated as follows.

In the bead pull-out test, test samples 56 were cut out from the two bead cores 50, which are provided for each tire, to each have a length of 25 mm as illustrated in FIG. 3B. For each of the test samples 56, four of the bead wires 54a in the bead core 50 illustrated in FIG. 3A were pulled out as illustrated in FIG. 3B. At this time, adhesiveness rates of the rubber adhering to the bead wires 54a were evaluated with naked eyes. The results are shown in Table 1 below.

In the present embodiment, eight of the bead wires 54a were pulled out from each tire. The adhesiveness rates of the rubber with respect to the eight bead wires 54a were evaluated with the naked eyes, and an average value thereof was calculated. Rubber adhesiveness rates were evaluated in Conventional Example 1, Examples 2 to 5, and Comparative Examples 1 to 3 relative to Example 1, based on an average value of Example 1 taken as 100. The larger the value of the rubber adhesiveness rate, the better the adhesion, indicating that the durability of the tire is higher.

TABLE 1

| | Coumarone resin film | | Rubber |
|---|---|---|---|
| | Viscosity | Film thickness | adhesiveness rate |
| | (Pa · sec) | (μm) | (%) |
| Example 1 | 600 | 0.10 | 100 |
| Example 2 | 2100 | 0.10 | 85 |
| Example 3 | 600 | 0.04 | 95 |
| Example 4 | 600 | 0.45 | 95 |
| Example 5 | 600 | 0.55 | 90 |
| Conventional | 280 | 0.10 | 60 |
| Example 1 | | | |
| Comparative | 330 | 0.10 | 80 |
| Example 1 | | | |
| Comparative | 2800 | 0.10 | 80 |
| Example 2 | | | |
| Comparative | 2800 | 0.55 | 75 |
| Example 3 | | | |

As shown in Table 1 above, in Examples 1 to 5, adhesiveness rates between bead wires and rubber were high and adhesion was good, thereby obtaining good results in terms of the durability of tires, as compared to those in Conventional Example 1 and Comparative Examples 1 to 3.

Meanwhile, in Conventional Example 1, since a coumarone resin had a low viscosity, an adhesiveness rate between bead wires and rubber was low and adhesion was poor, resulting in poor durability of a tire.

In Comparative Example 1, since a coumarone resin had a low viscosity, the coumarone resin was melted into a rubber composition before vulcanization, causing the rubber composition in an unvulcanized state to come into contact with bead wires. Accordingly, adhesion was poor and the durability of a tire was poor.

In Comparative Examples 2 and 3, since a coumarone resin had a high viscosity, the coumarone resin was left unmelted at the time of vulcanization. Accordingly, adhesion between a rubber composition and bead wires was poor after the vulcanization and the durability of a tire was poor.

### Second Embodiment

In a second embodiment, 1-2B peel-off tests were performed for rubber adhesiveness rates (%), each being an indicator for evaluating durability, with respect to tires manufactured.

In the second embodiment, pneumatic tires for Examples 10 to 14, Conventional Example 10, and Comparative Examples 10 to 12 were manufactured, using coumarone resin films each having a configuration shown in Table 2 below. For each of the pneumatic tires, a 1-2B peel-off test was performed to evaluate an adhesiveness rate between steel cords and rubber. Concerning the adhesiveness rate between the steel cords and the rubber, the results are shown in Table 2 below. In addition, the higher adhesiveness rate between the steel cords and the rubber, the superior adhesion, meaning that the tire has higher durability. Thus, the durability of the tire was evaluated based on the adhesiveness rate between the steel cords and the rubber.

In the second embodiment, tires each having a belt layer were manufactured using steel cords as reinforcing materials. The tires had a size of 215/65R16. For cord coating rubber for the steel cords, the rubber composition 52 (see FIG. 3A) of the bead core 50 (see FIG. 3A) as in the first embodiment described above was used.

In the belt layer configured to include the inner belt layer 22a and the outer belt layer 22b, the steel cords (2+2×0.25 HT), each of the steel cords having a coumarone resin film formed on a surface thereof, were embedded into each of the belt layers of the inner belt layer 22a and the outer belt layer 22b while being arranged at a density of 40 pieces per 50 mm. Prior to manufacturing the tire, the belt layer was stored in a chamber at a temperature of 30° C. and at a relative humidity (RH) of 90% for four days. Thereafter, the tire having the belt layer was manufactured. The 1-2B peel-off test was performed with respect to the tire manufactured.

In the 1-2B peel-off test, the inner belt layer of the belt layer was taken as a first belt 1B, and the outer belt layer was taken as a second belt 2B. The belt layer was cut out from the tire manufactured, and the peel-off test between the inner belt layer and the outer belt layer was performed. The steel cords after the peel-off test were taken out, and an adhesiveness rate of the rubber adhering to the steel cords was evaluated with naked eyes. The results are shown in Table 2. Viscosities shown in Table 2 below are viscosities at a temperature of 160° C. Further, a softening point of the coumarone resin films in Examples 10 to 14, Conventional Example 10, and Comparative Examples 10 to 12 is 98° C.

TABLE 2

| | Coumarone resin film | | Rubber |
|---|---|---|---|
| | Viscosity | Film thickness | adhesiveness rate |
| | (Pa · sec) | (μm) | (%) |
| Example 10 | 600 | 0.10 | 100 |
| Example 11 | 2100 | 0.10 | 85 |
| Example 12 | 600 | 0.04 | 95 |
| Example 13 | 600 | 0.45 | 95 |
| Example 14 | 600 | 0.55 | 90 |
| Conventional | 280 | 0.10 | 60 |
| Example 10 | | | |
| Comparative | 330 | 0.10 | 80 |
| Example 10 | | | |
| Comparative | 2800 | 0.10 | 80 |
| Example 11 | | | |
| Comparative | 2800 | 0.55 | 75 |
| Example 12 | | | |

As shown in Table 2 above, in Examples 10 to 14, adhesiveness rates between steel cords and rubber were high and adhesion was good, thereby obtaining good results in terms of the durability of the tires, as compared to Conventional Example 10 and Comparative Examples 10 to 12.

Meanwhile, in Conventional Example 10, since a coumarone resin had a low viscosity, an adhesiveness rate between steel cords and rubber was low and adhesion was poor, resulting in poor durability of a tire.

In Comparative Example 10, since a coumarone resin had a low viscosity, the coumarone resin was melted into a rubber composition before vulcanization, causing the rubber composition in an unvulcanized state to come into contact with bead wires. Accordingly, adhesion was poor and the durability of a tire was poor.

In Comparative Examples 11 and 12, since a coumarone resin had a high viscosity, the coumarone resin was left unmelted at the time of vulcanization. Accordingly, adhesion between a rubber composition and steel cords was poor after the vulcanization and the durability of a tire was poor.

1. A pneumatic tire using a reinforcing material having a coumarone resin film formed on a surface thereof,
the coumarone resin film comprising a coumarone resin having a viscosity from 350 to 2200 Pa·sec at a temperature of 160° C. and a softening point from 75 to 130° C., and
the reinforcing material being at least one of a bead wire or a steel cord.

2. The pneumatic tire according to claim 1, wherein the coumarone resin film has a thickness from 0.05 to 0.40 μm.
